(19) United States
(12) Patent Application Publication
(10) Pub. No.: US 2025/0030048 A1
(43) Pub. Date: Jan. 23, 2025

(54) ELECTROLYTE ADDITIVES FOR HIGH PERFORMANCE LITHIUM-SULFUR BATTERIES

(71) Applicant: UCHICAGO ARGONNE, LLC, Chicago, IL (US)

(72) Inventors: Zhengcheng Zhang, Naperville, IL (US); Qian Liu, Darien, IL (US)

(73) Assignee: UCHICAGO ARGONNE, LLC, Chicago, IL (US)

(21) Appl. No.: 18/221,961

(22) Filed: Jul. 14, 2023

(51) Int. Cl. H01M 10/0567; H01M 10/052; H01M 10/0569

(52) U.S. Cl. CPC H01M 10/0567; H01M 10/052; H01M 10/0569; H01M 2300/0037

(57) ABSTRACT

A lithium-sulfur battery providing stable, high energy density includes a cathode including sulfur, an anode including lithium metal, and an electrolyte including non-aqueous solvent and an additive including a fluorinated borate or a fluorinated borane; and lithium bis(nonafluorobutanesulfonyl)imide (LiNFBSI).

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to electrolytes for rechargeable electrochemical cells, and more specifically is related to electrolyte additives for lithium-sulfur batteries.

### BACKGROUND

Lithium-sulfur (Li—S) batteries are attractive for next generation energy storage, especially for large-scale applications such as electric vehicles and smart energy grids. Li—S batteries use earth abundant and environmentally friendly sulfur (S₈) and possess theoretical specific energy densities of about 2600 Wh kg⁻¹, several times higher than the state-of-the-art Li-ion batteries. However, Li—S batteries face several barriers to commercial adoption due to their poor cycling stability, particularly under commercially-practical conditions. Commercially-practical conditions may include complete utilization of thick sulfur cathodes (e.g., greater than 5 mAh cm⁻²), lean electrolyte, and thin Li anodes. The electrochemical reactions in Li—S batteries contribute to poor cycling stability under these conditions. In particular, the electrochemical reactions may produce highly soluble lithium polysulfide intermediates. These lithium polysulfide intermediates may deplete active sulfur at the cathode and active Li metal at the anode, and these losses may be more severe under practical condition. Shuttling of lithium polysulfide intermediates between the cathode and anode reduces Columbic efficiency and shelf life. In addition, the reaction products of S₈ and Li₂S are electrically insulating solid deposits that are difficult to re-activate, especially under commercially-practical conditions. Therefore, there is need for mechanisms to modulate lithium polysulfide conversion to facilitate high energy density and stable cycling Li—S batteries.

### SUMMARY

Electrolyte additives that modulate lithium polysulfide conversion for high energy density and stable cycling Li—S batteries under practical conditions are disclosed herein. The additives modulate lithium polysulfide intermediate conversion and facilitate solid-liquid-solid conversion to substantially prevent active material loss.

In an aspect, an electrochemical cell is provided comprising a cathode comprising sulfur; an anode comprising lithium metal; and an electrolyte comprising a non-aqueous solvent, and an additive comprising a fluorinated borate or fluorinated borane; and lithium bis(nonafluorobutanesulfonyl)imide (LiNFBSI).

In any embodiment, the fluorinated borate may comprise tris(2-fluoroethyl) borate, tris(2,2-difluoroethyl) borate, tris(2,2,2-trifluoroethyl) borate, or a mixture thereof. The fluorinated borate may be present in the electrolyte in a concentration of about 20 mM to about 500 mM or about 200 mM to about 300 mM. LiNFBSI may be present in the electrolyte at a concentration of about 0.9 M to about 1.1 M. The additive may comprise a mixture of a fluorinated borate and a fluorinated borane. Lithium polysulfide may be present in the electrolyte at a concentration of about 10 mM to about 200 mM. The non-aqueous solvent may comprise 1,2-dimethoxy ethane; 1,3-dioxolane; tetraethyleneglycol dimethyl ether; tetrahydrofuran; tri(ethylene glycol)dimethyl ether, fluorinated ethers, fluorinated glymes, or a mixture of two or more thereof. The non-aqueous solvent may comprise 1,2-dimethoxy ethane and 1,3-dioxolane in a v/v ratio of about 0.8:1.2 to about 1.2:0.8. The electrolyte may further comprise LiNO₃. The cathode may further comprise a conductive carbon.

In an aspect, a process for recovering insoluble sulfur species in an electrochemical cell is provided. The process comprises contacting Li₂S with S₈ in a non-aqueous solvent comprising TFEB to form a lithium polysulfide of formula Li₂Sₓ dissolved in the non-aqueous solvent, where x>2.

In any embodiment, the non-aqueous solvent may have a temperature of about 20° C. to about 30° C. The dissolved lithium polysulfide may be formed in less than about 60 seconds. The non-aqueous solvent may further comprise LiNO₃.

In an aspect, an electrolyte for a Li—S battery is provided. The electrolyte comprises a lithium polysulfide of formula Li₂Sₓ, where x>2, present in a concentration of about 100 mM to about 200 mM; a non-aqueous solvent comprising 1,2-dimethoxy ethane and 1,3-dioxolane in a v/v ratio of about 1:1; and a mixture of TFEB and LiNFBSI. The TFEB is present in the electrolyte in a concentration of about 20 mM to about 30 mM and the LiNFBSI is present in the electrolyte in a concentration of about 0.9 M to about 1.1 M.

### BRIEF DESCRIPTION OF THE DRAWINGS

FIG. 1 is a graph of UV-visible absorbance spectra comparing polysulfide solutions after mixing with different concentrations of TFEB.

FIG. 2 is a graph of cycling capacity of Li—S cells with different concentrations of TFEB.

FIG. 3 is a graph comparing rate performance of Li—S cells with different concentrations of TFEB from 0.05 C to 0.5 C.

FIG. 4 is a graph of self-discharge of Li—S cells with or without TFEB.

FIG. 5A is a graph of cycling capacity of Li—S cells with LiNFBSI or LiNFBSI and TFEB.

FIG. 5B is a graph of Coulombic efficiency for the cells in FIG. 5A.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Disclosed herein are electrolytes for use in lithium-sulfur (Li—S) batteries. The electrolytes include lithium polysulfides and anion acceptor materials. The anion acceptor materials modulate stable polysulfide conversion during battery cycling by forming complexes with sulfur-based materials in the battery. The anion acceptor materials are strong Lewis acids that react with lithium polysulfides, which are Lewis bases, to form strong redox-active species. The anion acceptors coordinate with polysulfides to create stable chemical complexes that do not compromise the electroactivity of the polysulfides. In this way, the anion acceptor materials facilitate solid-liquid-solid conversion during battery cycling.

The anion acceptor materials also increase sulfur utilization during battery cycling. The anion acceptor materials react with electrically insulating S and Li₂S solid materials to form electroactive sulfides, thereby activating or reactivating S and Li₂S solid materials that may otherwise be isolated and lost during battery cycling. In this way, the anion acceptor materials increase sulfur utilization.

The anion acceptor materials also perform a secondary role as anode and cathode protection additives by forming passivation layers on the surface of the lithium metal anode and the sulfur cathode. The redox reactions of the anion acceptor materials at the electrode surfaces may create stable interfacial films containing components of the anion acceptor materials. The anion acceptor materials passivate the sulfur cathode and Li metal anode and reduce polysulfide shuttling, thereby improving cycling stability and Coulombic efficiency. The anion acceptor materials may be reduced on the surface of the Li metal anode forming a robust solid-electrolyte interphase (SEI) that protects the surface of the anode. The robust SEI prevents or substantially reduces the formation of dendrites and provides regular lithium deposition and depletion. The SEI has a low resistivity, thereby facilitating fast charging of the Li—S battery.

The anion acceptor materials are strong Lewis acids. The anion acceptor materials may include fluorine-containing compounds. In any embodiment, the fluorine-containing compounds may include fluorinated borates (contain B—O bonds), fluorinated boranes (containing B—H bonds), and mixtures thereof.

The fluorinated borate may be represented by Formula I:

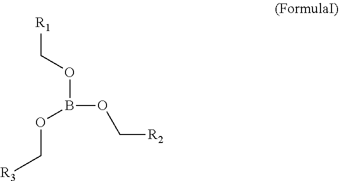

wherein R₁, R₂, or R₃ are each independently CH₃, CF₃, CF₂H, or CF₁H₂, and at least one of R₁, R₂, or R₃ is CF₃, CF₂H, or CF₁H₂. Examples of fluorinated borates include tris(2-fluorethyl) borate (Formula II), tris(2,2-difluorethyl) borate (Formula III), and tris(2,2,2-trifluoroethyl) borate (Formula IV), and mixtures of two or more thereof, as represented in the following chemical structures:

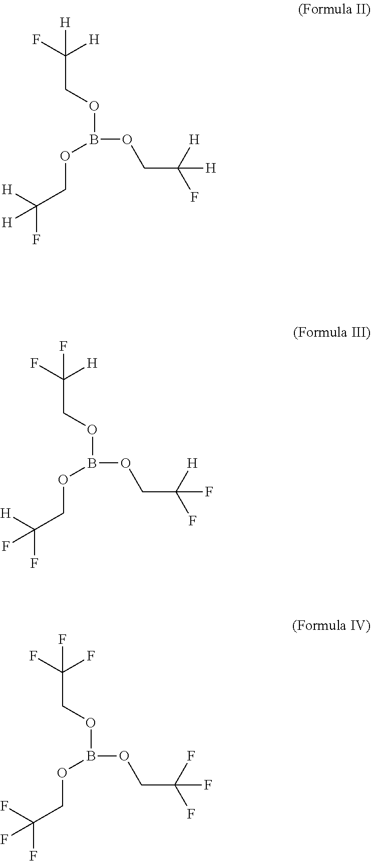 [SMILES: FCCOB(OCCF)OCCF ; FC(F)COB(OCC(F)F)OCC(F)F ; FC(F)(F)COB(OCC(F)(F)F)OCC(F)(F)F]

The fluorinated borane may be represented by Formula V:

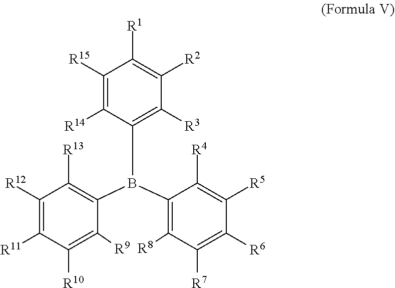

wherein R₁, R₂, R₃, R₃, R₄, R₅, R₆, R₇, R₈, R₉, R₁₀, R₁₁, R₁₂, R₁₃, R₁₄, and R₁₅ are each independently H or F, and at least one of R₁, R₂, R₃, R₃, R₄, R₅, R₆, R₇, R₈, R₉, R₁₀, R₁₁, R₁₂, R₁₃, R₁₄, or R₁₅ is F. Examples of fluorinated boranes include tris(pentafluorophenyl)borane (Formula VI), tris(tetrafluorophenyl)borane (Formula VII), tris(trifluorophenyl)borane (Formula VIII), tris(difluorophenyl)borane (Formula IX), and mixtures of two or more thereof, as represented in the following chemical structures:

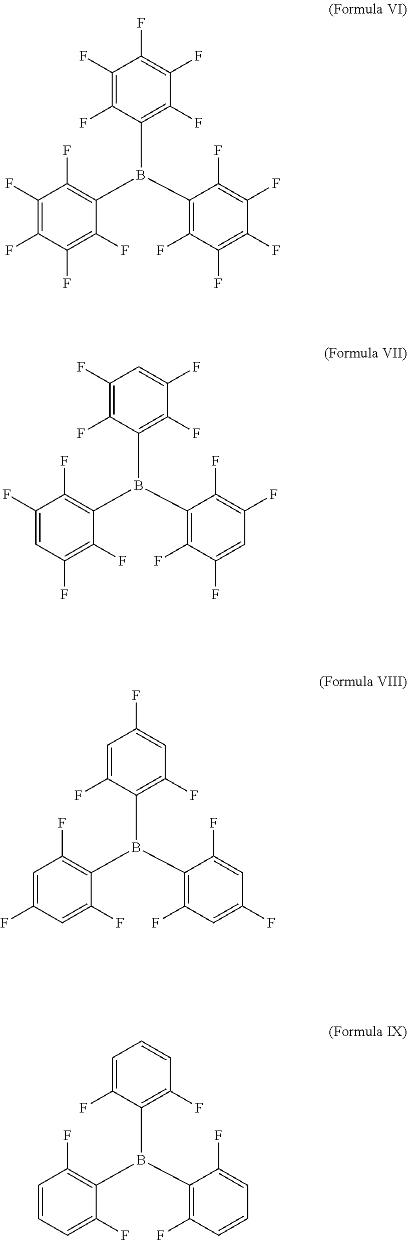 [SMILES: Fc1c(F)c(F)c(B(c2c(F)c(F)c(F)c(F)c2F)c2c(F)c(F)c(F)c(F)c2F)c(F)c1F ; Fc1cc(F)c(F)c(B(c2c(F)c(F)cc(F)c2F)c2c(F)c(F)cc(F)c2F)c1F ; Fc1cc(F)c(B(c2c(F)cc(F)cc2F)c2c(F)cc(F)cc2F)c(F)c1 ; Fc1cccc(F)c1B(c1c(F)cccc1F)c1c(F)cccc1F]

In any embodiment, the fluorine-containing compounds may also or alternatively include fluorinated organometallic lithium salts. The fluorinated organometallic lithium salts may include lithium bis(nonafluorobutanesulfonyl) imide (LiNFBSI). Without being bound by any theory, the anion acceptor materials may chemically bind with lone-pair-bearing nucleophiles in lithium polysulfides through nucleophilic pi-pi interactions.

Accordingly, in one aspect, an electrolyte for Li—S batteries is provided, the electrolyte including a lithium polysulfide of formula Li₂Sₓ, where x is 2 or greater; an anion acceptor; and a non-aqueous solvent.

The concentration of the anion acceptor in the solvent may be about 0.001 M to about 3 M. In some embodiments, the concentration of the anion acceptor in the solvent may be about 0.001 M to 2.0 M. In other embodiments, the concentration of the anion acceptor in the solvent may be about 0.01 M to 1.5 M. In yet other embodiments, the concentration of the anion acceptor in the solvent may be about 0.05 M to 1.3 M (including 0.1 M, 0.25 M, 0.5 M, 0.75 M, 1.0 M, 1.1 M, 1.2 M, and 1.3 M).

For example, the anion acceptor may include a fluorinated borate present in the solvent in a concentration of about 20 mM to about 500 mM or about 200 mM to about 300 mM, and any values therebetween. As another example, the anion acceptor may include LiNFBSI present in the solvent in a concentration of about 0.9 M to about 1.1 M (including 0.9 M, 1.0 M, and 1.1 M).

The anion acceptor in the solvent may be a single anion acceptor compound or a mixture of two or more anion acceptor compounds. For example, as illustrated in the Examples below, a mixture of a fluorinated borate and LiNFBSI may have a molar ratio of mixing of about 1 to 99 of fluorinated borate and from 99 to 1 of LiNFBSI. In some embodiments, the molar ratio of fluorinated borate to LiNFBSI is from 10:90 to 90:10. In some embodiments, the molar ratio of fluorinated borate to LiNFBSI is from 20:80 to 80:20. In some embodiments, the molar ratio of fluorinated borate to LiNFBSI is from 30:70 to 70:30.

When the solvent includes a mixture of two or more anion acceptors, the total concentration of the the anion acceptor in the solvent may be about 0.001 M to 2.0 M. In other embodiments, the total concentration of the anion acceptors in the solvent may be about 0.01 M to 1.5 M. In yet other embodiments, the total concentration of the anion acceptors in the solvent may be about 0.05 M to 1.3 M (including 0.1 M, 0.25 M, 0.5 M, 0.75 M, 1.0 M, 1.1 M, 1.2 M, and 1.3 M).

As an example, a mixture of a fluorinated borate or fluorinated borane and LiNFBSI may include the fluorinated borate or fluorinated borane present in a concentration of about 20 mM to about 500 mM, or about 20 mM to about 30 mM. In this mixture, the LiNFBSI may be present in a concentration of about 0.9 M to about 1.1 M.

The concentration of the lithium polysulfide in the solvent may be about 0.001 M to about 3 M. In some embodiments, the concentration of the lithium polysulfide in the solvent is about 0.001 M to 1 M. In some embodiments, the concentration of the lithium polysulfide in the solvent is about 0.001 M to 0.5 M. In other embodiments, the concentration of the lithium polysulfide in the solvent is about 0.1 M to 0.3 M. In yet other embodiments, the concentration of the lithium polysulfide in the solvent may be about 0.2 M.

The electrolyte may further include a charge carrier salt. The charge carrier salt may include lithium trifluoromethanesulfonamide (LiTFSI), lithium alkyl fluorophosphates; lithium alkyl fluoroborates; lithium 4,5-dicyano-2-(trifluoromethyl)imidazole; lithium 4,5-dicyano-2-methylimidazole; trilithium 2,2′,2″-tris(trifluoromethyl)benzotris(imidazolate); LiN(CN)₂; Li(CF₃CO₂); Li(C₂F₅CO₂); LiCF₃SO₃; LiCH₃SO₃; LiN(SO₂CF₃)₂; LiN(SO₂F)₂; LiC(CF₃SO₂)₃; LiN(SO₂C₂F₅)₂; LiClO₄; LiBF₄; LiAsF₆; LiPF₆; LiBF₂(C₂O₄), LiB(C₂O₄)₂, LiPF₂(C₂O₄)₂, LiPF₄(C₂O₄), LiAsF₆, LiN(SO₂CF₃)₂, LiN(SO₂F)₂, Li₂(B₁₂X₁₂₋ₚHₚ); Li₂(B₁₀X_{10-p′}H_{p′}); or a mixture of any two or more thereof, wherein X is independently at each occurrence a halogen, p is 0, 1, 2, 3, 4, 5, 6, 7, 8, 9, 10, 11, or 12, and p′ is 0, 1, 2, 3, 4, 5, 6, 7, 8, 9, or 10. The charge carrier salt may be present in the electrolyte at any amount including from about 0.1 M to 3 M, and any value there between. This may include a concentration from about 0.5 M to about 2 M. For example, the charge carrier salt may be 1.0 M LiTFSI.

The electrolyte may further include one or more shuttle inhibitor additives. The shuttle inhibitor additives may include LiClO₄ and/or other salts with ionic N—O bonds. Illustrative shuttle inhibitors include, but are not limited to, lithium nitrate, lithium nitrite, potassium nitrate, potassium nitrite, cesium nitrate, cesium nitrite, barium nitrate, barium nitrite, ammonium nitrate, ammonium nitrite, dialkyl imidazolium nitrates, guanidine nitrate, ethyl nitrite, propyl nitrite, butyl nitrite, pentyl nitrite octyl nitrite, nitromethane, nitropropane, nitrobutanes, nitrobenzene, dinitrobenzene, nitrotoluene, dinitrotoluene, nitropyridine, dinitropyridine, pyridine N-oxide, alkylpyridine N-oxides, and tetramethyl piperidine N-oxyl (TEMPO). The concentration of the shuttle inhibitor in the electrolyte is from about 0.01 weight percent (wt. %) to about 5 wt. %. In some embodiments, the concentration of the shuttle inhibitor in the electrolyte is from about 0.1 wt. % to about 3 wt. %. In some embodiments, the concentration is from about 1.5 wt. % to about 2.5 wt. %, such as about 2.0 wt. %. The shuttle inhibitors assist in the formation of a dense protective passive film on the surface of the anode which benefits the transfer of lithium ions and plays a role in preventing the reaction between polysulfides and the lithium anode.

Illustrative electrolyte solvents include, but are not limited to, acetals, ketals, sulfones, acyclic ethers, cyclic ethers, glymes, polyethers, dioxolanes, carbonates, silanes, siloxanes, ionic liquids, substituted forms of the foregoing, and blends or mixtures of any two or more such solvents. Examples of acyclic ethers that may be used include, but are not limited to, diethyl ether, dipropyl ether, dibutyl ether, dimethoxymethane, trimethoxymethane, dimethoxyethane (DME), diethoxyethane, 1,2-dimethoxypropane, and 1,3-dimethoxypropane. Examples of cyclic ethers that may be used include, but are not limited to, tetrahydrofuran (THF), tetrahydropyran, 2-methyltetrahydrofuran, 1,4-dioxane, 1,3-dioxolane (DOL), and trioxane. The cyclic ethers include non-polar fluorinated ether solvents, including, but not limited to, 1,1,2,2-tetrafluoroethyl-2,2,3,3-tetrafluoropropyl ether (TTE); 1,1,2,2-tetrafluoroethyl-2,2,3,3,3-pentafluoropropyl ether; 2,2,2-trisfluoroethyl-1,1,2,3,3,3-hexafluoropropyl ether; ethyl-1,1,2,3,3,3-hexafluoropropyl ether; difluoromethyl-2,2,3,3,3-pentafluoropropyl ether; difluoromethyl-2,2,3,3-tetrafluoropropyl ether; 2-fluoro-1,3-dioxolane; 2,2-difluoro-1,3-dioxolane; 2-trifluoromethyl-1,3-dioxolane; 2,2-bis(trifluoromethyl)-1,3-dioxolane; 4-fluoro-1,3-dioxolane; or 4,5-difluoro-1,3-dioxolane. Examples of polyethers that may be used include, but are not limited to, diethylene glylcol dimethyl ether (diglyme), triethylene glycol dimethyl ether (triglyme), tetraethylene glycol dimethyl ether (TEGDME), higher glymes, ethylene glycol divinylether, diethylene glycol divinylether, triethylene glycol divinylether, dipropylene glycol dimethylether, and butylene glycol ethers. Examples of sulfones that may be used include, but are not limited to, dimethylsulfoxide, sulfolane, 3-methyl sulfolane, and 3-sulfolene. Examples of carbonates that may be used include, but are not limited to, ethylene carbonate (EC), propylene carbonate (PC), ethylmethylcarbonate (EMC), dimethyl carbonate (DMC), and diethyl carbonate (DEC). Other electrolyte solvents that may be used include, but are not limited to, oligo (ethylene glycol)-substituted siloxanes, oligo (ethylene glycol)-substituted silanes, and ionic liquids.

In some embodiments, the electrolyte solvent includes, but is not limited to, 1,2-dimethoxy ethane (DME), 1,3-dioxolane (DOL), tetraethyleneglycol dimethyl ether (TEGDME), tetrahydrofuran (THF), and tri (ethylene glycol) dimethyl ether. Mixtures of any two or more such solvents may also be used. For example, a mixture of DME:DOL is illustrated in the examples, but other mixtures may be used. Where a mixture of two of the solvents is used, the ratio of mixing may be from 1 to 99 of a first solvent and from 99 to 1 of a second solvent. In some embodiments, the ratio of the first solvent to the second solvent is from 10:90 to 90:10. In some embodiments, the ratio of the first solvent to the second solvent is from 20:80 to 80:20. In some embodiments, the ratio of the first solvent to the second solvent is from 30:70 to 70:30. In some embodiments, the ratio of the first solvent to the second solvent is from 40:60 to 60:40. In some embodiments, the ratio of the first solvent to the second solvent is about 1:1. For example, as illustrated in the examples, one mixture is that of DME: DOL at a ratio of about 1:1.

In another aspect, a process for preparing the electrolyte is provided. The process includes contacting Li₂S and S₈ (or Li and S₈) in a non-aqueous solvent to form a suspension in the presence of the anion acceptor material to dissolve the Li₂S and S₈ (or Li and S₈) in the solvent and form a lithium polysulfide solution. A shuttle inhibitor and charge carrier salt may then be added to the lithium polysulfide solution, or the shuttle inhibitor and/or charge carrier salt may be added to the non-aqueous solvent prior to forming the suspension. The anion acceptor, charger carrier salt, and shuttle inhibitor may be added as a solid to the solvent or they may be added as stock solutions to the solvent.

Unlike conventional Li—S battery electrolytes, the electrolytes described herein do not require elevated temperatures to dissolve the Li₂S and S₈ (or Li and S₈) in the solvent and form a lithium polysulfide solution. The process of forming conventional electrolytes typically includes heating the solvent to elevated temperatures of about 50° C. to about 100° C. for about 10 hours to about 24 hours with constant stirring to form the lithium polysulfide solution. In contrast, here, the anion acceptor material increases the solubility of Li₂S and S₈ in the solvent so that the electrolyte can be formed rapidly at room temperature (i.e., 15° C. to 30° C.) without stirring. The period of time to dissolution may vary with the particulate size of the materials to be dissolved, the solvent, and the temperature. As an example, the electrolyte can be formed in about 30 seconds to about 30 minutes at a temperature of about 25° C. As another example, the electrolyte may be formed at room temperature in less than 60 seconds, less than 30 seconds, or less than 10seconds.

In another aspect, a Li—S battery is provided. The battery includes a sulfur-based cathode; a lithium metal anode; and any of the above electrolytes. The electrolyte may be present in the Li—S battery in an amount relative to the amount of sulfur in the cathode that is practical for commercial deployment of Li—S batteries. The amount of electrolyte relative to the amount of sulfur may be about 3 μL mg⁻¹ to about 10 μL mg⁻¹ (e.g., 3.5 μL mg⁻¹, 4 μL mg⁻¹, 4.5 μL mg⁻¹, 5 μL mg⁻¹, or 5.5 μL mg⁻¹). For example the amount of electrolyte may be about 4 μL mg⁻¹ to about 4.5 μL mg⁻¹, or about 4.2 μL mg⁻¹.

The cathode of the Li—S battery is a sulfur-based electrode that includes sulfur and may also include metal sulfide and/or conductive carbon. The sulfur may be elemental and provided as such. The sulfur may be combined with active metal sulfide materials. The metal sulfide materials may include Mo₆S₈. Examples of conductive carbons include synthetic graphite, natural graphite, amorphous carbon, hard carbon, soft carbon, acetylene black, mesocarbon microbeads (MCMB), carbon black, Ketjen® black, carbon Super P, mesoporous carbon, porous carbon matrix, carbon nanotube, carbon nanofiber, graphene, and mixtures of two or more thereof.

The cathode may be prepared by mixing sulfur with a conductive carbon material and a binding agent in the presence of a solvent to form a slurry. Illustrative binders include, but are not limited to, gelatine, polytetrafluoroethylene (PTFE), polyvinylidene fluoride (PVDF), polyethylenetetrafluoroethylene (ETFE), polyvinyl alcohol (PVA), polyethylene, polystyrene, polyethylene oxide, polyacrylonitrile, polyimide, polyamide, styrene butadiene rubber (SBR), carboxy methyl cellulose (CMC), alginate, gelatin, a copolymer of any two or more such polymers, or a blend of any two or more such polymers. The solvent may be N-methylpyrrolidone, acetone, water, or the like. The cathode may be prepared by coating and drying the mixture of the sulfur, carbon material, and binding agent directly on a current collector, or by casting the mixture on a separate support to form a film and then laminating the film on a current collector.

Illustrative anode materials include metallic lithium and carbon materials including, but not limited to, synthetic graphite, natural graphite, amorphous carbon, hard carbon, soft carbon, mesocarbon microbeads (MCMB), or a combination thereof. The anode active material may be a metallic lithium foil alone, metallic lithium mixed with an active carbon material, or metallic lithium intercalated within an active carbon material, where the active carbon material may be, but is not limited to, synthetic graphite, natural graphite, amorphous carbon, hard carbon, soft carbon, mesocarbon microbeads (MCMB).

According to some embodiments, the current collector may include copper, stainless steel, titanium, tantalum, platinum, gold, aluminum, nickel, cobalt nickel alloy, highly alloyed ferritic stainless steel containing molybdenum and chromium; or nickel-, chromium-, or molybdenum-containing alloys. The current collector is a foil, mesh, or screen and the cathode active material is contacted with the current collector by casting, pressing, or rolling the mixture thereto.

The battery may also include a separator between the anode and the cathode to prevent shorting of the cell. Suitable separators include those such as, but not limited to, microporous polymer films, glass fibers, paper fibers, and ceramic materials. Illustrative microporous polymer films include, but are not limited, nylon, cellulose, nitrocellulose, polysulfone, polyacrylonitrile, polyvinylidene fluoride, polypropylene, polyethylene, polybutene, or a blend or copolymer thereof. In some embodiments, the separator is an electron beam treated micro-porous polyolefin separator. In some embodiments, the separator is a shut-down separator. Other separators may include a microporous xerogel layer. Commercially available separators include those such as, but not limited to, Celgard® 2025 and 3501, and 2325; and Tonen Setela® E25, E20, and Asahi Kasei® and Ube® separators. The separator may be provided either as a free standing film or by a direct coating application on one of the electrodes. The electrolyte and structure of the present invention may be added to the separator during cell assembly or incorporated in a coating process. Separators of a wide range of thickness may be used. For example, the separator may be from about 5 μm to about 50 μm thick. In other embodiments, the separator is from about 5 μm to about 25 μm.

In another aspect, a method of cycling any of the electrochemical devices described herein is provided. The method may include cycling the electrochemical devices at a current from about C/30 to about 1 C, including any value there between (e.g., C/20, C/10, C/5, or C/2). For example, the range of currents may include about C/10 to about C/2. The method may include retaining a capacity and coulombic efficiency of at least about 80% over 200 electrochemical cycles, including at least about 90%, about 93%, and about 96%.

The present invention, thus generally described, will be understood more readily by reference to the following examples, which are provided by way of illustration and are not intended to be limiting of the present invention.

### EXAMPLES

Example 1. The poor cycling of high-capacity sulfur cathodes under commercially relevant conditions, including lean electrolyte conditions, is an ongoing challenge for practical deployment of Li—S batteries, and many of the challenges are associated with the polysulfide conversion pathway that involves soluble intermediates. The anion acceptor additive TFEB was added to the battery electrolyte to address these challenges. TFEB is a strong Lewis acid that strongly reacts with Li₂S and Li₂S₂ to form lithium polysulfides that are electro-active, thus facilitating the utilization of electronically insulating Li₂S and Li₂S₂ and improving the cycling stability of the Li—S cell. TFEB modulates polysulfide conversion. Electrodeposited Li₂S was readily charged back to S₈ with an overpotential dependent on the TFEB concentration in the electrolyte. Overall, Li—S batteries equipped with TFEB delivered a high specific capacity of 1350 mAh g⁻¹ at 0.1 C with a capacity retention of 96% after 200 cycles. TFEB helped facilitate stable and high-capacity cycling of dense sulfur cathodes under a low electrolyte to sulfur ratio (4.2 μL mg⁻¹), with capacity retentions of about 80% over 300 cycles.

Without being bound by any theory, a possible mechanism for the action of TFEB in Li—S batteries is provided. As a strong Lewis acid, TFEB is expected to chemically bind with lone-pair-bearing nucleophiles lithium polysulfides through nucleophilic pi-pi interaction.

Li₂S₄ and Li₂S₈ solutions with gradually increased TFEB concentration showed marked changes in coloration of the solution, from dark-red without TFEB to colorless with TFEB, and the degree of discoloration was dependent on the TFEB concentration. Such color changes may be attributable to the formation of chemical complexes of TFEB coordinated with polysulfides. NMR analysis of electrolyte containing TFEB pre-and post-cycling revealed substantially similar NMR chemical signatures, indicating that the complex is fairly stable during electrochemical cycling.

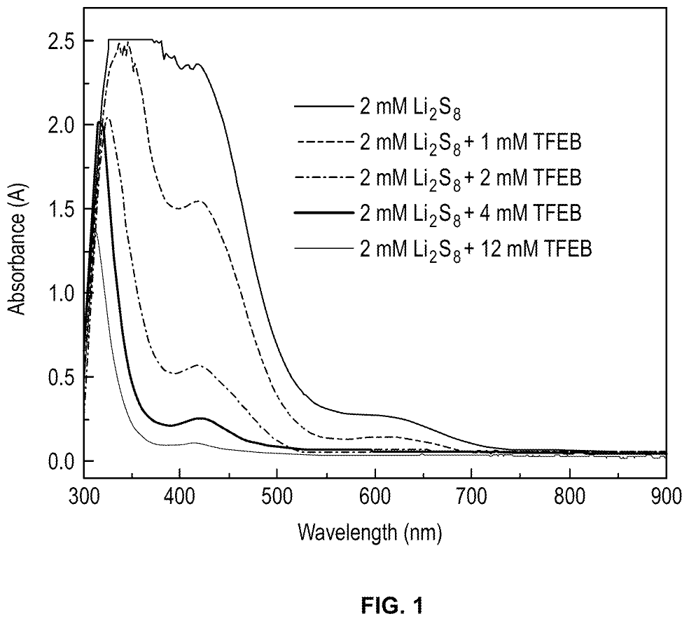

FIG. 1 is a graph of UV-Visible absorbance comparing lithium polysulfide solutions after mixing with different concentrations of TFEB. The polysulfide solutions were 2 mM Li₂S₈ in DOL/DME solvent with 1 mM TFEB, 2 mM TFEB, 4 mM TFEB, 12 mM TFEB, or without any TFEB. The solutions were mixed for ten minutes before UV-Visible absorbance spectra were acquired. The results indicated a drastic decrease in absorbance with increasing TFEB concentration, indicating the formation of complexes of TFEB with lithium polysulfide.

One of the challenges in Li—S batteries is the formation of isolated Li₂S during cycling and the difficulties to activate the isolated Li₂S deposits. TFEB was studied as an electrolyte additive that may activate isolated Li₂S deposits. Initial experiments contacted TFEB with Li₂S in DOL/DME solvent. Results showed that the addition of the TFEB additive to the Li₂S solution induced a distinct visual transformation of the solution from a colorless state to a yellowish state. These results indicate that the TFEB has strong interaction with Li₂S which may effectively increase the solubility of Li₂S, and may increase the conversion kinetics from inert Li₂S to highly reactive Li₂S₈. Another issue in Li—S batteries is that the conversion of Li₂S to Li₂Sₓ during charging typically requires a high activation energy due to the intrinsic inert properties of Li₂S. A common method to synthesize Li₂S₈ as catholyte is to react Li₂S and S₈ in a DOL/DME solvent, which typically requires heating and overnight stirring due to the inert nature of the Li₂S and S₈ reaction. In this study, the presence of TFEB in the DOL/DME solution propelled the rapid formation of Li₂S₈ within several seconds after adding Li₂S and S₈ solids in a stoichiometric ratio of 8:7 (to form Li₂S₈) to the DOL/DME/TFEB solution, without external heating or stirring. These results indicate that TFEB may have catalytic properties and can effectively promote the conversion of Li₂S to Li₂S₈ in Li—S batteries.

The ability of TFEB to improve Li₂Sₓ conversion kinetics was verified in a lithium polysulfide conversion study. A three-electrode cell system was employed, with lithium as both the counter and reference electrode, and glassy carbon as the working electrode. The electrolyte was 2 mM Li₂S₈ in DOL/DME solvent (in 1:1 ratio) with 2.0 wt. % LiNO₃. The results showed a reduction in the overpotential between the cathodic and anodic peaks following the addition of 1 mM TFEB to the electrolyte, as well as a clear right shift of the anodic peak, indicating the promotion of lithium polysulfide conversion kinetics. Furthermore, the peak current also increased in the presence of TFEB, suggesting an improvement in the charge transfer ability of the electrolyte.

The dissolution of lithium polysulfides in the electrolyte is another challenge in Li—S batteries that may lead to active material loss and capacity decay. Li—S catholyte batteries with a low concentration of catholyte (20 mM Li₂S₈) were used to investigate the impact of lithium polysulfide dissolution on electrochemistry in the presence of TFEB. The low Li₂S₈ concentration is known to result in capacity loss during cycling. The batteries in the catholyte study employed a lithium anode, a porous carbon cathode, and a base electrolyte consisting of 1.0 M LiTFSI with 2.0 wt. % LiNO3 in DME/DOL in a 1:1 ratio. Results indicated that the addition of 10 mM TFEB as an electrolyte additive was remarkably effective in eliminating lithium polysulfide dissolution and enhancing the Li₂Sₓ conversion kinetics. The battery with TFEB in the electrolyte demonstrated significantly improved capacity retention in the first 10 cycles, particularly in the first two cycles, compared to the battery without TFEB (92.8% vs. 62.5% capacity retention), which may be due to the TFEB mitigating the dissolution of sulfur species at the cathode surface, thus reducing active sulfur loss. Additionally, the battery discharge plateau voltage was increased in the battery with TFEB, which further indicates that the TFEB increased Li₂Sₓ conversion kinetics.

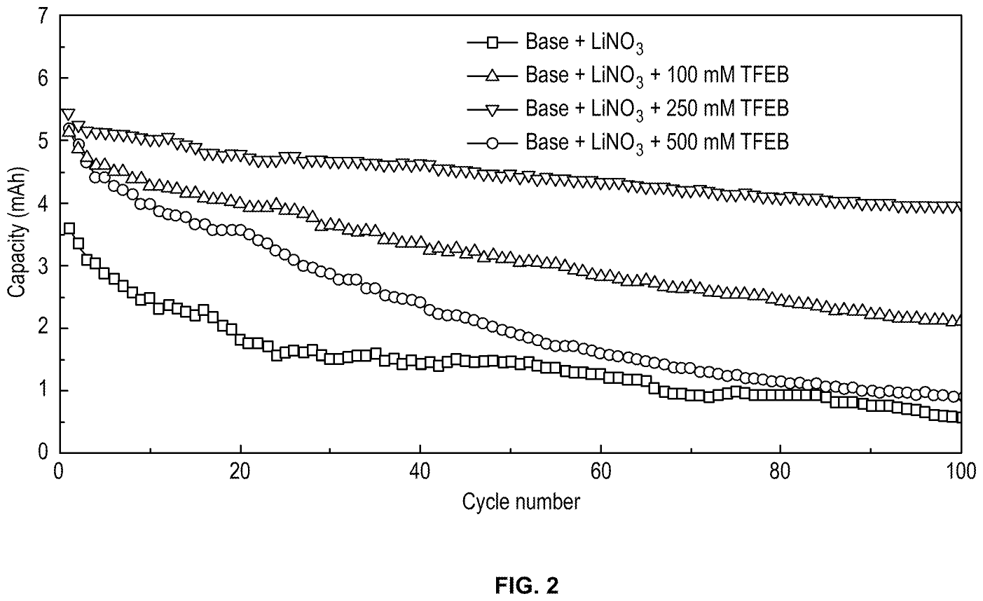

FIG. 2 is a graph of cycling capacity of Li—S cells with different concentrations of TFEB, indicating improved Li₂S activation kinetics when TFEB was used. The Li—S cells were assembled with high-capacity sulfur electrodes and lean electrolytes to evaluate commercially-practical conditions. The cathodes were fabricated by mixing carbon/sulfur, Mo₆S₈, carbon Super P, and carbon nanotube and then coating the mixture on aluminum foil with a mass loading of about 5.0 mg cm⁻². The anodes were thin metallic lithium foil (about 10 mg cm⁻²). The electrolyte-to-sulfur ratio was about 4, representing lean electrolyte conditions.

The addition of 100 mM or 250 mM TFEB to the electrolyte effectively improved the battery's discharge capacity, discharge voltage and Columbic efficiency compared with the electrolyte without TFEB. The battery without TFEB in the electrolyte exhibited very sluggish kinetics as characterized by low capacity and high overpotential. The battery with 250 mM TFEB delivered a high specific capacity of 1350 mAh g⁻¹ at 0.1 C. The battery with 250 mM TFEB demonstrated a capacity of 1088 mAh/g and 94.6% efficiency after 200 cycles at 0.1 C. In comparison, the battery without TFEB in the electrolyte exhibited a Columbic efficiency of only 70.1% after 200 cycles and had an initial capacity that was much lower. Of note is that further increases in TFEB concentration from 250 mM to 500 mM deteriorated the cell performance both in capacity retention and the Coulombic efficiency.

FIG. 3 is a graph comparing rate performance of Li—S cells with different concentrations of TFEB from 0.05 C to 0.5 C. The battery using an electrolyte with TFEB additive exhibited remarkable rate capability and retained a high capacity of 432.1 mAh g⁻¹ at 0.5 C, representing a capacity retention of 40.3% (compared with a capacity of 1125.5 mAh g⁻¹ at 0.02 C). In comparison, the battery with an electrolyte without TFEB showed lower capacities at 0.05 C of 725.3 mAh g⁻¹, and capacity retention was only 18.6% at 0.5 C (to 142.5 mAh g⁻¹).

The cycling stability of the batteries with TFEB may result from the TFEB forming stable SEI layers, increasing Li₂S conversion kinetics, and reducing lithium polysulfide dissolution. These results suggest TFEB may be an effective electrolyte additive for high energy density and durable Li—S batteries under practical conditions.

The addition of TFEB also improved Li surface stability in the presence of a high concentration of lithium polysulfide. Experiments were conducted to measure the impact of TFEB on electrochemical Li plating/stripping. The experimental setup utilized lithium as the anode, copper foil as the cathode, and an electrolyte of 1.0 M LiTFSi with the addition of 100 mM Li₂S₈ to simulate practical lithium sulfur battery working conditions. The improved electrolyte was 1.0 M LiTFSI with TFEB and 100 mM Li₂S₈. The results showed that the addition of TFEB decreased the overpotential for Li plating and stripping. Furthermore, electrochemical impedance spectroscopy (EIS) of the cycled Li—Cu cells revealed a reduction in both charge transfer resistance and bulk resistance when TFEB was used. Overall, the results suggest that the utilization of TFEB as an electrolyte additive has great potential to improve the efficiency and stability of the lithium anode for high sulfur-loading and lean-electrolyte Li—S batteries.

In order to investigate the mechanism by which the TFEB additive positively impacts lithium anode protection in the presence of lithium polysulfides in the electrolyte, the Li—Cu cells were disassembled following 100 cycles under Li-stripping conditions. A black solid electrolyte interphase (SEI) had formed on the Cu surface in both cells, but with the presence of TFEB in the electrolyte, there was no obvious evidence of lithium left on the Cu surface after Li stripping. In contrast, in the cell without TFEB in the electrolyte, bright and shiny lithium was present on the surface of the black SEI, likely indicating that the black SEI on the Cu surface was blocking both the electron and lithium ion transfer processes, resulting in the formation of significant amounts of dead lithium and a reduced coulombic efficiency.

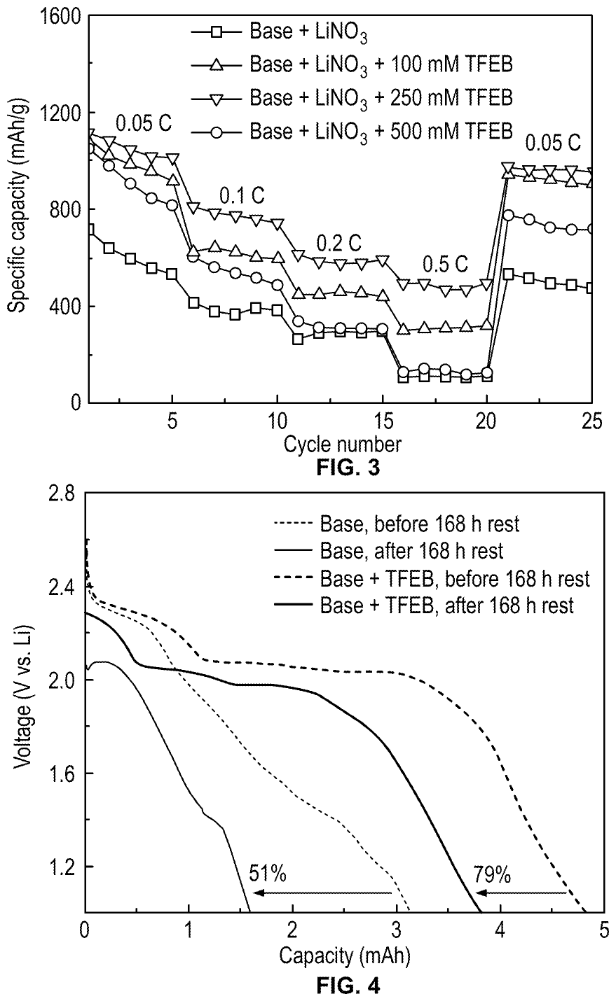

FIG. 4 is a graph of self-discharge of Li—S cells with or without TFEB. Self-discharge of Li—S batteries is a challenge for created batteries with long shelf lives. Charged sulfur electrode surfaces in Li—S batteries are typically unstable, and gradually decay due to spontaneous chemical reactions with the electrolyte and within the electrode. The self-discharge behavior with and without TFEB was measured over 168 hours after charging the batteries. The battery with TFEB experienced 21% self-discharge, while the battery without TFEB experienced 49% self-discharge. These results indicate that the TFEB increases battery shelf life.

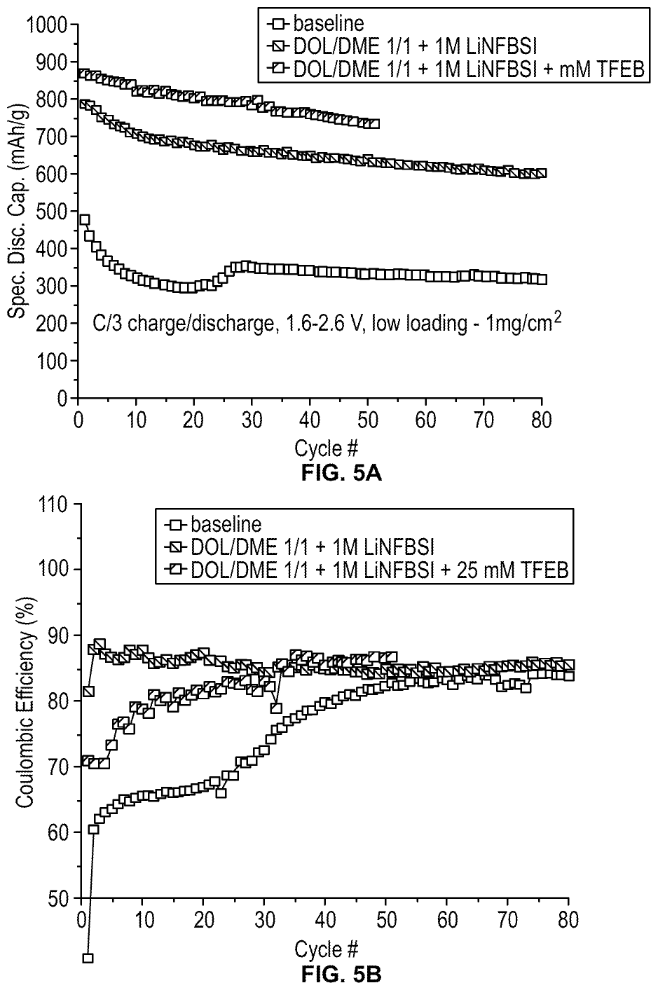

Example 2. FIG. 5A is a graph of cycling capacity of Li—S cells with LiNFBSI or LiNFBSI and TFEB anion acceptor additives, as compared to Li—S cells without these anion acceptor additives. FIG. 5B is a graph of Coulombic efficiency for the cells in FIG. 5A. In one condition, the LiNFBSI additive was present at a concentration of 1 M in the electrolyte, and TFEB was present in a concentration of 23 mM in the electrolyte. In another condition, the electrolyte included the LiNFBSI additive at a concentration of 1 M, but did not include TFEB.

Li—S cells with LiNFBSI alone or Li—S cells with LiNFBSI and TFEB had greater initial discharge capacity and improved capacity retention over 80 cycles as compared to Li—S cells without these additives. Comparing the Li—S cells with LiNFBSI and TFEB to the Li—S cells with just NFBSI, the addition of TFEB decreased the initial Coulombic efficiency, but the efficiency recovered with cycling.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrochemical cell comprising:
a cathode comprising sulfur;
an anode comprising lithium metal;
an electrolyte comprising:
a non-aqueous solvent; and
an additive comprising a fluorinated borate or a fluorinated borane; and
lithium bis(nonafluorobutanesulfonyl)imide (LiNFBSI).

2. The electrochemical cell of claim 1, wherein the fluorinated borate comprises tris(2-fluoroethyl) borate, tris(2,2-difluoroethyl) borate, tris-(2,2,2-trifluoroethyl)borate (TFEB), or a mixture thereof.

3. The electrochemical cell of claim 1, wherein the fluorinated borate comprises tris-(2,2,2-trifluoroethyl)borate (TFEB).

4. The electrochemical cell of claim 1, wherein fluorinated borate is present in the electrolyte in a concentration of about 20 mM to about 500 mM.

4. The electrochemical cell of claim 1, wherein fluorinated borate is present in the electrolyte in a concentration of about 200 mM to about 300 mM.

5. The electrochemical cell of claim 1, wherein fluorinated borane comprises tris(pentafluorophenyl)borane, tris(tetrafluorophenyl)borane, tris(trifluorophenyl)borane, tris(difluorophenyl)borane, or a mixture of any two or more thereof.

6. The electrochemical cell of claim 1, wherein the LiNFBSI is present in the electrolyte at a concentration of about 0.9 M to about 1.1 M.

7. The electrochemical cell of claim 1, wherein the additive comprises the fluorinated borate and the fluorinated borane.

8. The electrochemical cell of claim 6, wherein the fluorinated borate is present in the electrolyte at a concentration of about 20 mM to about 30 mM and LiNFBSI is present in the electrolyte in a concentration of about 0.9 M to about 1.1 M.

9. The electrochemical cell of claim 1, wherein lithium polysulfide is present in the electrolyte at a concentration of about 10 mM to about 200 mM.

10. The electrochemical cell of claim 1, wherein the non-aqueous solvent comprises 1,2-dimethoxy ethane; 1,3-dioxolane; tetraethyleneglycol dimethyl ether; tetrahydrofuran; tri(ethylene glycol)dimethyl ether, fluorinated ethers, fluorinated glymes, or a mixture of two or more thereof.

11. The electrochemical cell of claim 1, wherein the electrolyte further comprises LiNO₃.

12. The electrochemical cell of claim 1, wherein the cathode further comprises a conductive carbon.

13. A process for recovering insoluble sulfur species in an electrochemical cell, the process comprising:
contacting Li₂S with S₈ in a non-aqueous solvent comprising tris-(2,2,2-trifluoroethyl) borate (TFEB) to form a lithium polysulfide of formula Li₂Sₓ dissolved in the non-aqueous solvent, where x>2.

14. The process of claim 13, wherein the non-aqueous solvent has a temperature of about 20° C. to about 30° C.

15. The process of claim 13, wherein the dissolved lithium polysulfide is formed in less than 60 seconds.

16. The process of claim 13, wherein the non-aqueous solvent further comprises LiNO₃.

17. The process of claim 13, wherein the TFEB is present in the non-aqueous solvent at a concentration of about 200 mM to about 300 mM.

18. The process of claim 13, wherein the non-aqueous solvent comprises 1,2-dimethoxy ethane; 1,3-dioxolane; tetraethyleneglycol dimethyl ether; tetrahydrofuran; tri(ethylene glycol)dimethyl ether, or a mixture of two or more thereof.

19. An electrolyte for a lithium-sulfur battery, the electrolyte comprising:
a non-aqueous solvent; and lithium bis(nonafluorobutanesulfonyl)imide (LiNFBSI).

20. The electrolyte of claim 19, wherein the LiNFBSI is present in the electrolyte in a concentration of about 0.9 M to about 1.1 M.
